(19) United States
(12) Patent Application Publication
(10) Pub. No.: US 2005/0154762 A1
(43) Pub. Date: Jul. 14, 2005

(54) Fast rule lookup with arbitrary IP range configurations

(76) Inventor: Bing Wang, San Jose, CA (US)

Correspondence Address: DARBY & DARBY P.C., P.O. BOX 5257, NEW YORK, NY, 10150-6257, US

(21) Appl. No.: 10/757,801

(22) Filed: Jan. 14, 2004

(51) Int. Cl. G06F 17/00

(52) U.S. Cl. 707/104.1

(57) ABSTRACT

Enabling a relatively fast look up for a rule associated with an arbitrarily selectable IP address. In one embodiment, RSBound objects are sorted into an array where each RSBound object is composed of a bound IP address (BIP), sister BIP, type, index, sister index, and a configured rule. The BIPs are derived from arbitrary user-specified IP addresses or IP address ranges. Each single IP address configuration derives one RSBound entry, where the BIP is the given IP address itself; and each IP range configuration derives two RSBound entries, and the range's lower bound and upper bound are their respective BIPs. The array is sorted primarily based on the RSBound's BIP value, and their type and pair information are the tiebreakers. If a configured rule needs to be searched for a given IP address, a binary search is performed first to find a starting entry, from where a jump-skip search is performed to find the best matching rule for the given IP address. Additionally, although this invention is well suited for IP range matching, it can also be used to match keys with arbitrary ranges of other non-IP address types, e.g., mobile telephone numbers.

### FIELD OF THE INVENTION

The present invention relates to configurations based on IP address ranges, and in particular, to a method and system for providing fast rule lookup for arbitrary ranges of IP addresses.

### BACKGROUND OF THE INVENTION

IP address based configurations are often employed in network applications. For example, features incorporated in Simple Mail Transport Protocol (SMTP) daemons, such as anti-spam black/white lists are often configured on the base of the clients' IP addresses. For these features, rules are frequently predefined and associated with IP addresses or IP address ranges, where the applicable rules for given IP addresses are then looked up by finding the best matches among these predefined addresses and ranges. However, for applications that are capable of making thousands of connections per second, performance can be an issue in regard to IP address/range matching.

The Classless Inter-Domain Routing (CIDR) subnet technique, which is typically used in network routers, has been an ad-hoc format for IP address range matching. Although the CIDR subnet technique is generally suited for use with network routers, its strictness in format can make user configuration limited when it is used for high layer applications (layers higher than the network layer, i.e., layers 4-7 in the OSI model). For example, with the CIDR subnet method, a user is not able to specify an arbitrary non-subnet range of IP addresses such as 192.168.1.20 through 192.168.1.97, which can be needed for network management in high layer applications.

Thus, it is with respect to these considerations and others that the present invention has been made.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description of the Invention, which is to be read in association with the accompanying drawings, wherein:

FIG. 1 illustrates one embodiment of an environment in which the invention may operate;

FIG. 2A shows a graphical representation of ranges of IP addresses that are neither equivalent to each other nor arranged crosswise with each other;

FIG. 2B illustrates a graphical representation of ranges of IP addresses that are substantially equivalent to each other;

FIG. 2C shows a graphical representation of ranges of IP addresses that are arranged crosswise to each other;

FIG. 3A illustrates a table with single IP addresses and ranges of IP addresses that are separately associated with a rule;

FIG. 3B shows a graphical representation of the relationship between the different ranges of IP addresses and single IP addresses that are separately associated with a rule;

FIG. 4 illustrates a sorted array of boundIPs, sister boundIPs, Type (single, upper bound or lower bound), Index, sister Index, and rule, and wherein the sorted array is arranged with a table that graphically represents jump-skip searches for several IP addresses; and

FIG. 5 shows a flow chart for one embodiment, in accordance with the present invention.

### DETAILED DESCRIPTION OF THE INVENTION

The present invention now will be described more fully hereinafter with reference to the accompanying drawings, which form a part hereof, and which show, by way of illustration, specific exemplary embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

The terms “comprising,” “including,” “containing,” “having,” and “characterized by,” refers to an open-ended or inclusive transitional construct and does not exclude additional, unrecited elements, or method steps. For example, a combination that comprises A and B elements, also reads on a combination of A, B, and C elements.

The meaning of “a,” “an,” and “the” include plural references. The meaning of “in” includes “in” and “on.” Additionally, a reference to the singular includes a reference to the plural unless otherwise stated or is inconsistent with the disclosure herein.

The term “or” is an inclusive “or” operator, and includes the term “and/or,” unless the context clearly dictates otherwise.

The phrase “in one embodiment,” as used herein does not necessarily refer to the same embodiment, although it may.

The term “based on” is not exclusive and provides for being based on additional factors not described, unless the context clearly dictates otherwise.

The term “flow” includes a flow of packets through a network. The term “connection” refers to a flow or flows of messages that typically share a common source and destination.

Briefly stated, the present invention is directed to a method and system for enabling a relatively fast look up for a rule associated with an arbitrarily selectable IP address. In one embodiment, RSBound objects are sorted into an array where each RSBound object is composed of a bound IP address (BIP), type, pair information (sister BIP, index, sister index) and a configured rule. The BIPs are derived from arbitrary user-specified IP addresses or IP address ranges. Each single IP address configuration derives one RSBound entry, where the BIP is the given IP address itself; and each IP range configuration derives two RSBound entries, and the range's lower bound and upper bound are their respective BIPs. The array is sorted primarily based on the RSBound's BIP value, and their type and pair information are the tiebreakers. Additionally, although this invention is well suited for IP range matching, it can also be used to match keys with arbitrary ranges of other non-IP address types, e.g., mobile telephone numbers, and the like.

Illustrative Operating Environment

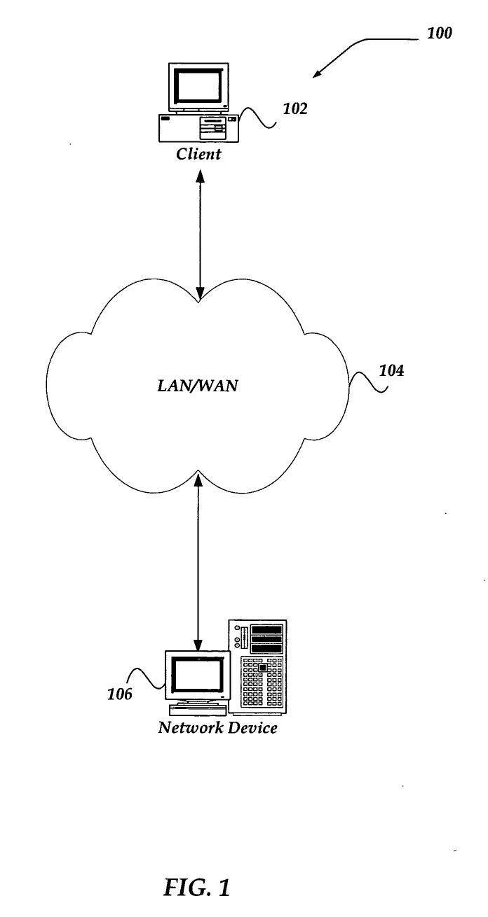

FIG. 1 illustrates one embodiment of an environment in which the invention may operate. Not all the components may be required to practice the invention, and variations in the arrangement and type of the components may be made without departing from the spirit or scope of the invention.

As shown in the figure, system 100 includes Local Area Network/Wide Area Network (LAN/WAN) 104, client 102, and a network device 106. Client 102 and network device 106 are in communication over LAN/WAN 104.

LAN/WAN 104 is enabled to employ any form of computer readable media for communicating information from one electronic device to another. In addition, LAN/WAN 104 may include the Internet in addition to local area networks, wide area networks, direct channels, such as through a universal serial bus (USB) port, other forms of computer-readable media, and any combination thereof. On an interconnected set of LANs, including those based on differing architectures and protocols, a router acts as a link between LAN's, enabling messages to be sent from one to another. Also, communication links within LANs typically include twisted pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. Furthermore, remote computers and other related electronic devices may be remotely connected to either LANs or WANs via a modem and temporary telephone link. In essence LAN/WAN 104 may include any communication mechanism by which information may travel between network devices, such as client 102 and network device 106.

Client 102 may be any network device capable of communicating over a network, such as LAN/WAN 104, to network device 106, and the like. Client 102 may allow one or more users, such as an administrator to access resources over LAN/WAN 104 such as network device 106. The set of such devices may include devices that typically connect using a wired communications medium such as personal computers, multiprocessor systems, microprocessor-based or programmable consumer electronics, network PCs, and the like, that are configured to operate as a client. The set of such devices may also include devices that typically connect using a wireless communications medium such as cell phones, smart phones, pagers, radio frequency (RF) devices, infrared (IR) devices, CBs, integrated devices combining one or more of the preceding devices, and the like, that are configured as a client. Alternatively, client 102 may be any device that is capable of connecting using a wired or wireless communication medium such as a PDA, POCKET PC, wearable computer, and any other device that is equipped to communicate over a wired and/or wireless communication medium, operating as a client.

Network device 106 may include any computing device or devices capable of providing a user access to a resource, such as an application on network device 106, and the like. Devices that may operate as network device 106 include, but are not limited to, personal computers, desktop computers, multiprocessor systems, microprocessor-based or programmable consumer electronics, network PCs, web servers, cache servers, file servers, routers, gateways, switches, bridges, firewalls, proxies, and the like. In one embodiment network device 106 may operate as a network appliance comprising a plurality of applications and their associated management servers.

Although not shown, a plurality of applications and their associated management servers may reside in network device 106 or reside in another network device and be managed by network device 106.

General and Illustrative Operations

Generally, when an IP address is provided, the invention first performs a binary search to find a starting entry for the given IP address in a sorted array. From the starting entry, a jump-skip search is performed to find the best match to an RSBound entry (a lower-bound or single type entry if left-heading search is performed). If a configured rule is associated with this best match RSBound entry, the rule is identified and subsequently employed for further processing of the IP address.

IP Range Validation

Listed below are exemplary embodiments for defining single, range and CIDR subnet specified addresses.
Single IP addresses, e.g. [192.168.1.2]
IP ranges, e.g. [192.168.1.20-192.168.1.97]
CIDR subnets, e.g. [192.168.1.0/24] (which is equivalent to 192.168.1.0-192.168.1.255).

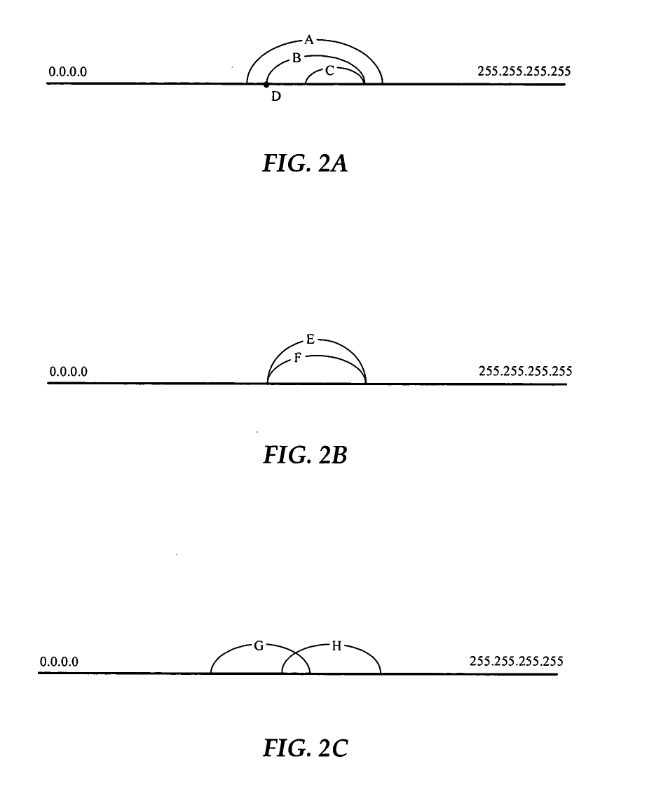

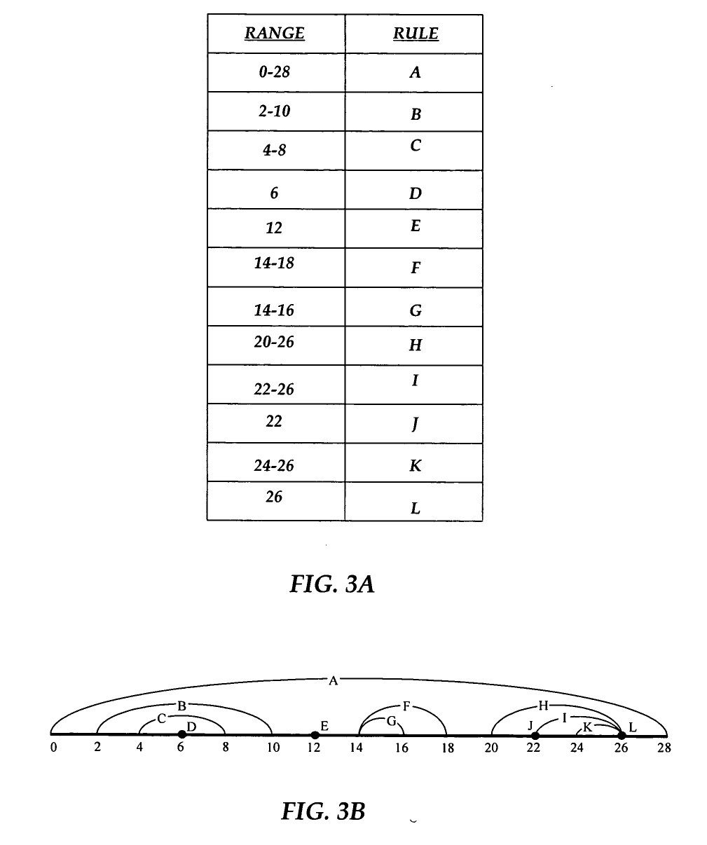

Although IP ranges can be nested, they should not conflict, e.g., two ranges should not be equal or cross. Otherwise, a rule found for the IP address in between would not be unique. In FIG. 2A, since the IP address ranges associated with configured rules A, B, C, D are unique, they can all coexist in the invention. However, as shown in FIG. 2B, IP address ranges that are equivalent to each other can cause a conflict for configured rules (E and F). Similarly, FIG. 2C illustrates IP address ranges that are crosswise to each other that cause a conflict for configured rules G and H. For configured rules, equivalent IP addresses/ranges and ranges that are crosswise to each other are substantially unsuited for use with most embodiments of the invention.

For computational purposes, the IP addresses are converted from dot notation (X.X.X.X) to an integer representation. In the example below, l denotes the IP address range's lower bound, and u denotes the range's upper bound (for single IP address, l=u). Also, A will conflict with B if one of following three conditions is met:
A.l<B.l and B.l≦A.u<B.u
B.u≧A.l>B.l and A.u>B.u
A.l=B.l and A.u=B.u

Thus, as shown in FIG. 2A for valid rule configurations, the IP address ranges associated with the configured rules should not conflict.

RSBound Object

As discussed above, configuration data is built into a sorted array, and each entry of the array is an RSBound object derived from the specified IP addresses and ranges as well as the associated rules. Each single IP address derives one RSBound entry, and each IP range derives two entries (for its lower bound and upper bound respectively).

The RSBound object has at least the following data fields:

bip—BIP of this bound.

sisterbip—Another BIP of the corresponding IP range. (sisterbip=bip if the bound is derived from a single IP address).

type—Type of this bound, indicating whether this is a lower bound, a upper bound, or a single IP address.

index—Index of this object in the sorted array.

sisterindex—Index of the another RSBound object derived from the same IP range.

rule—Rule associated with the single IP address or IP range configuration, from which this bound is derived.

Sorting of the RSBound

The sorted array is made of RSBound objects where the RSBound objects are compared primarily based on the values of their BIPs. Thus, for RSBound objects A and B,

If A.bip>B.bip, then A>B.

If A.bip<B.bip, then A<B.

Also, when the BIPs of two RSBounds are identical, their type and the sisterbip value will become the tiebreaker.

For example, if a left-heading search is assumed, the following tie-breaking procedure would be followed:

(1) If A.type is single, then A>B; else

(2) If B.type is single, then A<B;

(3) Otherwise,
(a) if A.sisterbip>B.sisterbip, then A<B; else
(b) if A.sisterbip<B.sisterbip, then A>B.

Additionally, if the sorted array is disposed on a line where the smaller entries are positioned on the left, the tie-breaking procedure would be that the bound derived from a single IP address configuration will always be on the right side of RSBound objects with the same BIP without regard as to whether those RSBound objects are a lower-bound or a upper-bound. Also, the RSBound objects derived from an inner IP range are always enclosed by the RSBound objects derived from the outer IP range. This tie-breaking procedure is with the left-heading-jump-skip search technique. If the RSBound is not sorted in this way, the exemplary jump-skip search cannot be performed during a left-heading search.

Additionally, if a right-heading search was to be used, the first two tie-breaking rules would be reversed and substantially the same actions would be performed except in the right heading direction.

The exemplary tie-breaking procedure discussed above covers substantially all scenarios. In particular, unlisted conditions are disqualified by the IP range validation. Also, in the case where A.bip=B.bip, it is mandated that A.sisterbip≠B.sisterbip. Further, if A is a lower bound, B must also be a lower bound. Similarly, if A is a upper bound, B must also be a upper bound.

Searching For Rules For An IP address

In one embodiment, the configured rule for a given IP address is looked up in two steps, i.e., determining the starting entry and the jump-skip search.

To determine the starting entry, a binary search is performed on the sorted array to find the starting entry. If a left-heading search is performed, the starting entry would be as follows:

(1) the last entry of the sorted array, if the given IP address matches the BIP of the last entry; or

(2) an entry in the sorted array whose BIP is smaller or equal to the given IP address, but the BIP of the next entry to its right is greater than the given IP address.

If the BIP of the starting entry is equal to the given IP address, and the bound is either a lower-bound or a single IP address, then the starting entry is the best match, and the rule associated with the starting entry will be the configured rule for the given IP address.

Once the starting entry is determined, a left leading jump skip search can be performed as follows:

(1) Set the current pointer to the starting entry;

(2) If the current entry's BIP equals the given IP address;
(a) If the current entry is either a lower-bound or a single IP address, then the best-match is found, the rule associated with the current entry is returned and stop;
(b) Otherwise, move the current pointer one entry left; go to (3), and repeat (3)-(6) until false

(3) If current entry is a single IP address, move the current pointer one entry left, and repeat (3)-(6) until false;

(4) If current entry is a lower bound, then the best-match is found, the associated rule is returned and stop;

(5) Otherwise, if current entry's BIP equals to the given IP address, move the current pointer one entry left, and repeat (3)-(6) until false;

(6) Otherwise, move the current pointer to the entry left to the current entry's sister entry (leap-skip), and repeat (3)-(6) until false.

Case Study

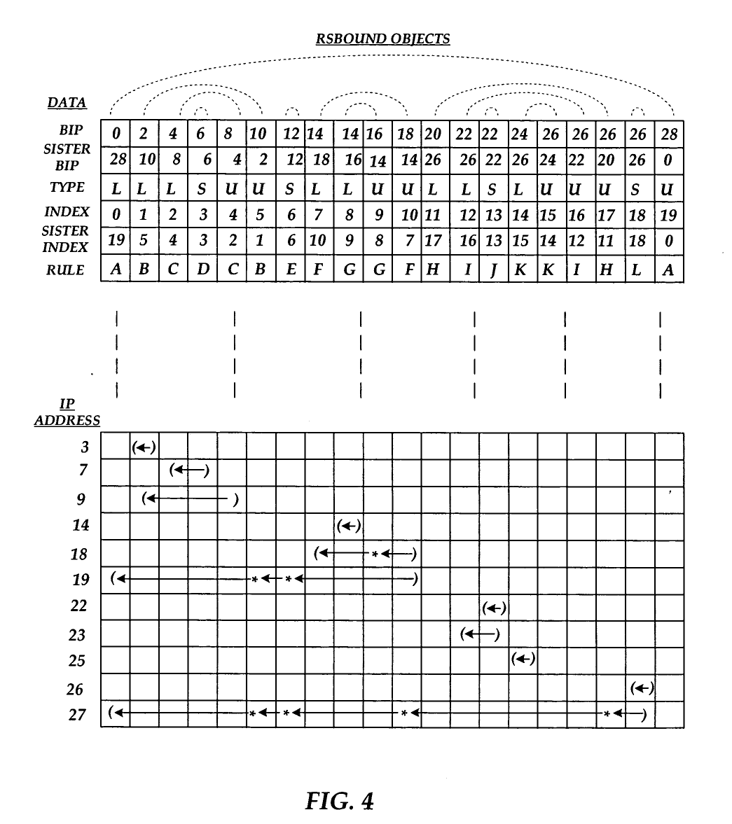

FIG. 4 illustrates two tables that show the association of each RSBound object with data fields in a sorted array. Above the upper table for the sorted array, dotted lines graphically show the relationship between RSBound objects that are associated with either a single IP address or a range of IP addresses. Also, the upper table shows each RSBound object arranged as a column with five rows associated with each column. Each row represents a separate data field, i.e., BIP, Sister BIP, Type, Index, Sister Index, and Rule. Since IP addresses are represented as integers for computational purposes by this embodiment, integers are used for exemplary IP addresses. Also, the smaller RSBound objects are disposed to the left of the sorted array.

Additionally, the lower table for the sorted array is arranged to show the paths taken by several jump-skip searches for several IP addresses, including 3, 7, 9, 14, 18, 19, 22, 23, 25, 26, and 27. As can be seen in this figure, the invention enables a relatively fast and efficient left heading search for a configured rule for a given IP address based on either a single address or a lower bound for a range of IP addresses that is relatively the “best match” for the given IP address. The left opening parenthesis “)” indicates a starting entry for the jump-skip search and the right opening parenthesis “(” indicates the relatively best match. The asterisk “*” indicates intermediate entries that are checked as the search jumps and skips to the relatively best match.

Additionally, although the embodiment discussed above performs a left heading search for the relatively best match for a given IP address, the invention is not so limited. Instead, the search for the relatively best match for a given IP address could be a right heading search for either a single IP address or an upper bound for a range of IP addresses in substantially the same way (albeit in the opposite direction) as the left heading search discussed elsewhere in the specification.

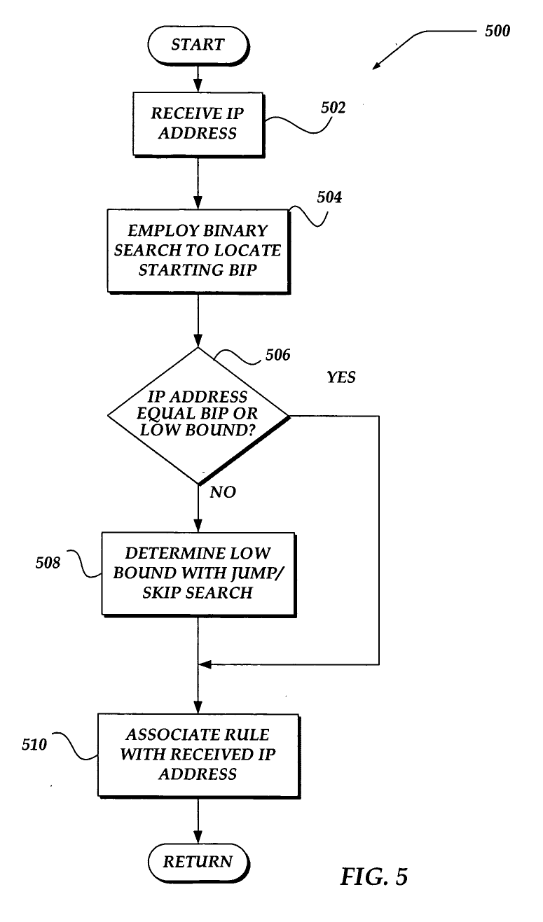

FIG. 5 illustrates a flowchart 500 for a process to enable a relatively fast and efficient left heading search for a configured rule for a given IP address based on either a single address or a lower bound for a range of IP addresses that is relatively the “best match” for the given IP address. Moving from a start block, the process advances to block 502 where the IP address is provided. Next, the process addresses to block 504 where a relatively direct search, such as a binary search, and the like, is performed to determine the starting entry (RSBound Object associated with data fields, including a BIP) in the sorted array. Next, the process steps to decision block 506 where a determination is made as to whether the starting entry is either a single IP address or a lower bound of a range of IP addresses that are equivalent to the given IP address. If true, the process jumps to block 510 and the configure rule that is associated with either the single IP address or lower bound is associated with the received IP address for subsequent processing. Next, the process steps to the return block and returns to performing other actions.

However, if the determination at decision block 506 was false, the process would step to block 508 where the jump/search search would be performed to determine a lower bound that is substantially the best match for the given IP address, as discussed above and illustrated in FIG. 4. Next, the process would move to block 510 and perform substantially the same actions and subsequently return to performing other actions.

It will be understood that each block of the flowchart illustrations discussed above, and combinations of blocks in the flowchart illustrations above, can be implemented by computer program instructions. These program instructions may be provided to a processor to produce a machine, such that the instructions, which execute on the processor, create means for implementing the actions specified in the flowchart block or blocks. The computer program instructions may be executed by a processor to cause a series of operational steps to be performed by the processor to produce a computer-implemented process such that the instructions, which execute on the processor, provide steps for implementing the actions specified in the flowchart block or blocks.

Although the invention is described in terms of communication between a client and a server, the invention is not so limited. For example, the communication may be between virtually any resource, including but not limited to multiple users, multiple servers, and any other device, without departing from the scope of the invention.

Accordingly, blocks of the flowchart illustrations support combinations of means for performing the specified actions, combinations of steps for performing the specified actions and program instruction means for performing the specified actions. It will also be understood that each block of the flowchart illustrations, and combinations of blocks in the flowchart illustrations, can be implemented by special purpose hardware-based systems, which perform the specified actions or steps, or combinations of special purpose hardware and computer instructions.

1. A method for associating at least one rule with a key, comprising:
arranging a plurality of objects in a table that is based on an ordering of information associated with each object;
if the key is provided, employing at a search method to determine a starting entry in the table;
if the starting entry in the table is unequal to the provided key, employing another search method to determine an object in the table that is relatively equivalent to the key; and
enabling the processing of the key based on at least one rule associated with the object.

2. The method of claim 1, wherein the search method includes at least a binary search.

3. The method of claim 1, wherein the search method determines if the provided key is equal to a single key associated with one object in the table.

4. The method of claim 1, wherein the search method determines if the provided key is equal to a lower bound of a range of keys associated with one object in the table, wherein the other search method operates in a left direction across the table.

5. The method of claim 1, wherein the search method determines if the provided key is equal to an upper bound of a range of keys associated with one object in the table, wherein the other search method operates in a right direction across the table.

6. The method of claim 1, wherein the key is at least one of an IP address and a telephone number.

7. The method of claim 6, wherein the key is the IP address and information associated with the object includes at least one of a bound IP address, sister bound IP address, type, index, sister index, and rule.

8. The method of claim 1, wherein the table includes at least an array, wherein the information associated with each object is sorted in the array.

9. The method of claim 1, wherein the other search method further includes:
searching from the starting entry in a left direction across the table to iteratively determine a lower bound of a range of keys associated with one object that is relatively equivalent to the provided key, wherein the other search method enables jumping over other objects in the table to determine the relatively equivalent lower bound; and
enabling the processing of the key based on at least one rule associated with the one object that is associated with the relatively equivalent lower bound.

10. The method of claim 1, wherein the other search method further includes:
searching from the starting entry in a right direction across the table to iteratively determine an upper bound of a range of keys associated with one object that is relatively equivalent to the provided key, wherein the other search method enables jumping over other objects in the table to determine the relatively equivalent upper bound; and
enabling the processing of the key based on at least one rule associated with the one object that is associated with the relatively equivalent upper bound.

11. A network device for associating at least one rule with a key, comprising:
a memory for storing instructions;
a processor for enabling actions based on the instructions, including:
arranging a plurality of objects in a table that is based on an ordering of information associated with each object;
if the key is provided, employing at a search method to determine a starting entry in the table;
if the starting entry in the table is unequal to the provided key, employing another search method to determine an object in the table that is relatively equivalent to the key; and
enabling the processing of the key based on at least one rule associated with the object.

12. The network device of claim 11, wherein the search method includes at least a binary search.

13. The network device of claim 11, wherein the search method determines if the provided key is equal to a single key associated with one object in the table.

14. The network device of claim 11, wherein the search method determines if the provided key is equal to a lower bound of a range of keys associated with one object in the table, wherein the other search method operates in a left direction across the table.

15. The network device of claim 11, wherein the search method determines if the provided key is equal to an upper bound of a range of keys associated with one object in the table, wherein the other search method operates in a right direction across the table.

16. The network device of claim 11, wherein the key is at least one of an IP address and a telephone number.

17. The network device of claim 16, wherein the key is the IP address and information associated with the object includes at least one of a bound IP address, sister bound IP address, type, index, sister index, and rule.

18. The network device of claim 11, wherein the network device operates as at least one of a router, firewall, switch, hub, and server array controller.

19. The network device of claim 11, wherein the other search method further includes:
searching from the starting entry in a left direction across the table to iteratively determine a lower bound of a range of keys associated with one object that is relatively equivalent to the provided key, wherein the other search method enables jumping over other objects in the table to determine the relatively equivalent lower bound; and
enabling the processing of the key based on at least one rule associated with the one object that is associated with the relatively equivalent lower bound.

20. The method of claim 11, wherein the other search method further includes:
searching from the starting entry in a right direction across the table to iteratively determine an upper bound of a range of keys associated with one object that is relatively equivalent to the provided key, wherein the other search method enables jumping over other objects in the table to determine the relatively equivalent upper bound; and
enabling the processing of the key based on at least one rule associated with the one object that is associated with the relatively equivalent upper bound.

21. A network device for associating at least one rule with a key, comprising:
a means for arranging a plurality of objects in a table that is based on an ordering of information associated with each object;
a means for employing at a search method to determine a starting entry in the table if the key is provided;
a means for employing another search method to determine an object in the table that is relatively equivalent to the key if the starting entry in the table is unequal to the provided key; and
a means for enabling the processing of the key based on at least one rule associated with the object.
